(19) United States
(12) Patent Application Publication
(10) Pub. No.: US 2017/0197741 A1
(43) Pub. Date: Jul. 13, 2017

(54) METHOD AND DEVICE FOR HEAT-SEALING A LID ONTO THE RIM OF A GLASS

(71) Applicant: 1/4 VIN, Sollies Pont (FR)

(72) Inventors: Pascal CARVIN, Sollies Pont (FR); Christian MURA, Le Plan Du Castellet (FR)

(73) Assignee: 1/4 VIN, Sollies Pont (FR)

(21) Appl. No.: 15/314,708

(22) PCT Filed: Jun. 16, 2015
(86) PCT No.: PCT/FR2015/051598

§ 371 Date: Nov. 29, 2016

(30) Foreign Application Priority Data
Jun. 17, 2014 (FR) 1401368

(51) Int. Cl. B65B 7/28; B29C 65/00; A47G 19/22; B65B 51/10; B65B 3/04; B65B 31/04; B65D 81/20; B65D 85/72; B29C 65/18; B65D 77/20

(52) U.S. Cl. CPC B65B 7/2878; B29C 65/18; B29C 66/00141; B29C 66/53461; B29C 66/8161; B29C 66/8324; B29C 66/8322; B29C 66/71; A47G 19/2205; B65D 77/2024; B65B 3/04; B65B 31/04; B65D 81/2076; B65D 85/72; B65B 51/10; B29L 2031/7132

(57) ABSTRACT

The invention relates to a device for heat sealing a film lid placed on the rim of a glass, the device comprising a deformable and thermally conductive element designed to press against the film lid and the rim and to heat the film lid and the rim. A peripheral portion of the conductive element is arranged to extend beyond the rim. The device has means for hinging and suspending the conductive element, and means for transmitting a pressure force exerted by an actuator to the conductive element, which force transmission means are distinct from the means for hinging and suspending the conductive element.

### TECHNICAL FIELD

The present invention relates to a method and to a device for heat sealing a film lid on the rim of a glass.

The invention relates in particular to heat sealing a film lid on the rim of a glass made of plastics material and filled with wine packaged under a modified atmosphere.

### STATE OF THE ART

Packaging wine in a closed drinking glass is described in patent FR 2 735 003. The container described in that patent comprises a closure element fitting closely to the wall of the container so as to seal the packaging, and having a plane bottom face that is situated close to the free surface of the wine so as to define a residual space, also referred to as the “head space”, that is small. The glass is made of glass or of plastics material.

Patent EP 1 235 501 proposes packaging wine in a closed container of overall permeability to oxygen that is small enough to enable wine to be conserved for a long time. The container is made of glass and it is closed by a heat-sealable film lid comprising a layer of aluminum coated in a protection layer. The wine is packaged under an oxygen-poor atmosphere; as a result the head space defined by the film lid, the wall of the glass, and the free surface of the wine contains little oxygen, thereby limiting oxidation of the wine.

That patent describes a packaging device having a station for heat sealing a film lid on the rim of a glass being moved by a conveyor, the station having an actuator for vertically moving a tool including a resistive heater element and a solid metal part coated on its bottom face with a deformable pad made of a thermally conductive material, such as silicone.

International application WO 2006/136694 describes a device for packaging a beverage in glasses that are moved by a conveyor, in which the glasses are placed in pots carried by the conveyor. The device has a heat-sealing station with means for inerting a glass that is already filled with wine, which means comprise a porous duct fed with inert gas under pressure so as to deliver a slow stream of inert gas for filling the head space.

International application WO 2010/106239 describes a glass made of plastics material in which the top end of the edge or rim of the glass has an annular rib made of thermoplastic material presenting a section of upside-down T-shape, such that two collection surfaces, or volumes, lying on either side of the rib and set back from the top of the rib receive the material that results from flattening the rib while heat sealing a film lid on the rim. That serves to increase the contact area between the rim and the film of material used for sealing a film lid to the rim, but without increasing the width or thickness of the rim, thereby increasing the ability of the film lid to withstand being torn off, decreasing the oxygen permeability of the connection zone, and in particular of the sealing film, interconnecting the rim and the film lid, and limiting or avoiding the presence of any projecting residues after the film lid has been torn off.

If the heat -sealing tool and the rim of the glass are out of parallel, that can lead to defective sealing of the glass closed by the heat-sealed film lid.

This is particularly critical when the rim includes a meltable portion that deforms during heat sealing, since it can lead to non-uniform deformation around the rim, and also to the formation of projections that are undesirable for the comfort of the user of the beverage-filled glass.

The tool and the rim may be out of parallel in particular as a result of the rim and the foot of the glass being out of parallel.

When the glass is placed on a conveyor via a glass support such as a pot, the tool and the rim being out of parallel can result from the heat-sealing tool and the conveyor being out of parallel, and/or from the bearing face of the glass support on the conveyor and the bearing face of the glass on the glass support being out of parallel.

### SUMMARY OF THE INVENTION

An object of the invention is to propose a method and a device for heat sealing a film lid on the rim of a glass, which method and device make it possible to compensate for the rim of the glass and the heat-sealing tool being out of parallel.

An object of the invention is to propose a method and a device for heat sealing a film lid on the rim of a glass that are improved and/or that remedy, at least in part, the shortcomings or drawbacks of previously known heat sealing methods and devices.

An object of the invention is to propose a method and a device for heat sealing a film lid on the rim of a glass that can be used for closing glasses having respective rims that present a variety of shapes.

An object of the invention is to propose a method and a device for heat sealing a film lid on the rim of a glass made of thermoplastic material that presents, in section, a rib that is meltable at least in part during heat sealing, and in particular a rib of upside-down T-shape, which method and device are improved.

In an aspect of the invention, there is provided a heat-sealing device comprising an element that is deformable (compressible) and thermally conductive that is designed to press against a film lid placed on the rim of a glass and to heat the film lid and the rim, the device having a peripheral portion that is arranged to project beyond, i.e. outside, the rim, in particular for the purpose of pressing down a peripheral portion of the film lid towards the outside face of the rim (or a side wall of the glass beneath the rim), this (deformable) conductive element also being mounted in hinged and suspended (hanging) manner, in particular so as to compensate at least in part for the rim and the conductive element being out of parallel.

In other words, the heat-sealing device includes in particular means for suspending and hinging the conductive element relative to an actuator that is used for moving said element, in particular a linear actuator such as a hydraulic jack.

The deformation capacity of the conductive element can compensate for the rim not being entirely plane or for the rim being rough, and can therefore avoid a sealing defect.

When the rim of the glass is deformed (by creep of the plastics material constituting the rim of the glass), i.e. when it is melted in part during heat sealing, the pressure exerted on the film lid and on the rim by the deformable conductive element that “overhangs” the rim, leads to the outer portion of the rim being rounded or curved, and avoids projections being formed on the outer edge of the rim.

In particular when, at the end of heat sealing, the rim of the class has a section of curved outline, specifically a section of rounded of or a section of curved outline resulting from the rib on the rim deforming (melting), the deformable conductive element may present thickness, diameter, and elasticity (compressibility) that are sufficient to deform while fitting closely to the (outer) lateral peripheral portion of the rim, thus enabling the peripheral portion of the film lid to be heat sealed onto the peripheral portion of the rim all along its curved profile.

The deformable conductive element may be in the form of a disk or a ring; in particular, it may be made of silicone; it presents a greatest dimension, in particular an outside diameter, that is greater than the diameter of the rim.

The (deformable) conductive element may be suspended in particular by means of one or more slides, or equivalent guide members, that enable the conductive element to move in translation relative to a linear actuator of the heat-sealing tool, and in particular to move in translation along the travel axis of the actuator.

The means for suspending the conductive element may also include one or more low-stiffness springs co-operating respectively with the one or more slides, thus making it possible in particular for the conductive element to exert a negligible pressure force on the film lid and on the rim at the end of the stroke imparted by the actuator to the deformable conductive element, i.e. a pressure force that is much less than that needed for heat sealing the film lid on the rim.

In particular, each spring may press against a slide in order to form a kind of pusher.

Thus, between the head coming into contact with the rim and the end of the travel imparted to the conductive element by the actuator, the pressure force exerted by the conductive element on the film lid and on the rim is very low, thereby making it easier to ensure that the conductive element and the rim are arranged in parallel as is made possible by the conductive element being hinged, thereby subsequently making it possible to apply a uniform pressure force all around the rim, and consequently to improve the quality with which the film lid is sealed.

Hinging the deformable conductive element preferably enables said element to pivot about two pivot axes that are substantially orthogonal (mutually perpendicular) and that may be substantially perpendicular to the axis of the pressure force exerted by the actuator on the conductive element, and/or to the axis of the pressure force exerted by the conductive element on the film lid and on the rim.

The deformable conductive element is generally incorporated in a heat-sealing tool having a metal part secured to the conductive element and a heater element, in particular a resistive heater element, the heat-sealing tool being fastened to a rod of a linear actuator (such as a hydraulic jack) designed to exert a pressure force that is transmitted by the metal part to the conductive element so that it presses against the film lid and consequently against the rim.

In order to hinge the conductive element for pressing against and heating the film lid, the heat-sealing tool may comprise a first tool portion that is rigidly fastened to the rod of the actuator, and a second tool portion that is hinge-mounted on, or relative to, the first tool portion, the second tool portion including the metal part, the heater element, and the deformable conductive element.

The second tool portion is preferably suspended (hung) from the first tool portion, by means of said slide(s). In order to obtain both significant mutual hinging capacity between the first and second tool portions, and secondly suspension of the second tool portion relative to the first tool portion, the second tool portion may comprise a body pierced by parallel channels, each channel having an abutment and receiving one of said springs, in particular a helical spring extending along the longitudinal axis of the channel, and the first tool portion may include parallel slides, in particular slides in the form of rods that are partially engaged in respective ones of the channels, and that press against respective ones of said springs, each slide being arranged to slide in one of the channels with clearance that also allows the slide to tilt relative to the longitudinal axis of the channel, the slides co-operating with respective abutments that prevent the slides from escaping from the channels.

Alternatively, the body pierced with channels may be fastened to or integral with the first tool portion while the slides may be fastened to or integral with the second tool portion.

In an embodiment, the number of channels and the number of slides may be equal to three.

The stiffness of said springs may be selected so as to compensate for the weight of said second tool portion, i.e. the weight of the suspended portion of the heat-sealing tool, so that the springs can support this portion of the tool when the heat-sealing tool is turned upside-down by pivoting the tool about a horizontal axis so as to enable a film lid to be gripped by a pneumatic gripper such as a suction cup that is incorporated in the bottom portion of the sealing head, as described for example in above-mentioned application WO 2006/136694.

The springs serve to hold the bottom portion of the sealing head in line with the top portion of the head during such pivoting movements of the head so that the bottom portion is properly positioned, after pivoting, and so that the film lid is deposited on and put into contact with the rim by the pneumatic gripper in correct manner.

In the event that the rim is not parallel to the bottom face of the sealing tool, the means for hinging and suspending the thermally conductive element, and in particular the means for hinging and suspending the first and second tool portions relative to each other, serve in particular to enable the conductive element to pivot without effort about its first point of contact or pressure against the rim during the movement of being brought to press against the film lid and the rim.

This pivoting movement then serves to limit or avoid the film lid sliding on the rim and/or the conductive element sliding on the film lid, thereby improving sealing.

The heat-sealing device also includes means for transmitting a pressure force exerted by an actuator to the conductive element, which means are distinct (separate) from the means for hinging and suspending the conductive element.

These force transmission means preferably include a force transmission part that may be rigidly connected to one of the first and second tool portions, in particular to the second tool portion and to the conductive element, this part having a bearing surface extending between the first and second tool portions, preferably a bearing surface that is domed.

Various other equivalent means may be provided for hinging and suspending the conductive element relative to the rod of the actuator used for moving the heat-sealing tool.

Furthermore, the heat-sealing device preferably includes a device for introducing an inert gas into the head space with the help of a porous structure, in particular a device for injecting inert gas at low speed, such as that described in international application WO 2006/136694.

In another aspect of the invention, there is provided a method of heat sealing a film lid on the rim of a glass in which use is made of a heat-sealing device of the invention.

The invention applies in particular to heat sealing an indented and/or stamped film lid on the rim of a glass, in particular a glass made of polyethylene terephthalate (PET) that may be fabricated in particular by an injection blow-molding method, and that may present a rim of transverse profile that presents a rib in the form of an upside-down T-shape, and possibly also the other characteristics described in international application WO 2010/106239.

Other aspects, characteristics, and advantages of the invention appear in the following description, which refers to the accompanying figures and shows preferred embodiments of the invention, without any limiting character.

### BRIEF DESCRIPTION OF THE FIGURES

FIG. 1 is a diagrammatic side view of an embodiment of a heat-sealing tool, and constitutes a view of detail A in FIG. 4.

FIG. 2 is a diagrammatic side view of the heat-sealing tool shown in FIG. 1, while pressing against the rim of a glass that is initially parallel to the conductive element of the heat-sealing tool.

FIG. 3 is a diagrammatic side view of the heat-sealing tool shown in FIG. 1, while pressing against the rim of a glass that is not initially parallel to the conductive element of the heat-sealing tool, i.e. that is not perpendicular to the travel axis of the heat-sealing tool. FIG. 3 constitutes a view of detail B in FIG. 5.

FIG. 4 is a diagrammatic side view of a heat-sealing device including the heat-sealing tool shown in FIG. 1 prior to heat sealing, the tool being arranged at a distance from the rim of a glass that is not parallel to the deformable conductive element.

FIG. 5 is a diagrammatic side view of the heat-sealing device shown in FIG. 4 during heat sealing, the conductive element of the heat-sealing tool pressing against the rim of a glass that is not perpendicular to the travel axis of the heat-sealing tool.

FIG. 6 is a diagrammatic section view showing the deformation of the periphery of a conductive element held pressed against a film lid resting on the rim of a glass, while the film lid is being heat sealed.

### DETAILED DESCRIPTION OF THE INVENTION

Unless specified explicitly or implicitly to the contrary, elements or members that are structurally or functionally identical or similar are designated in the various figures by references that are identical.

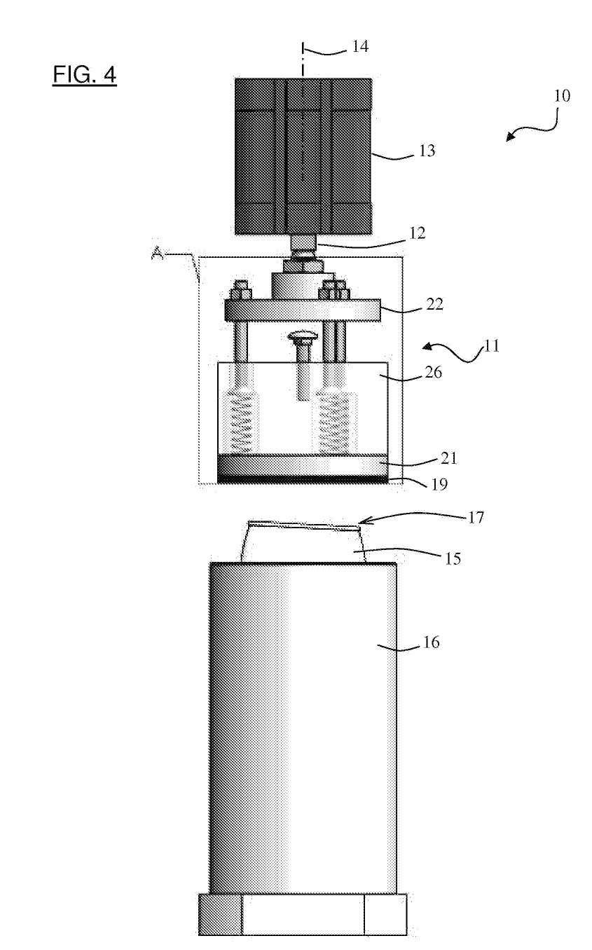

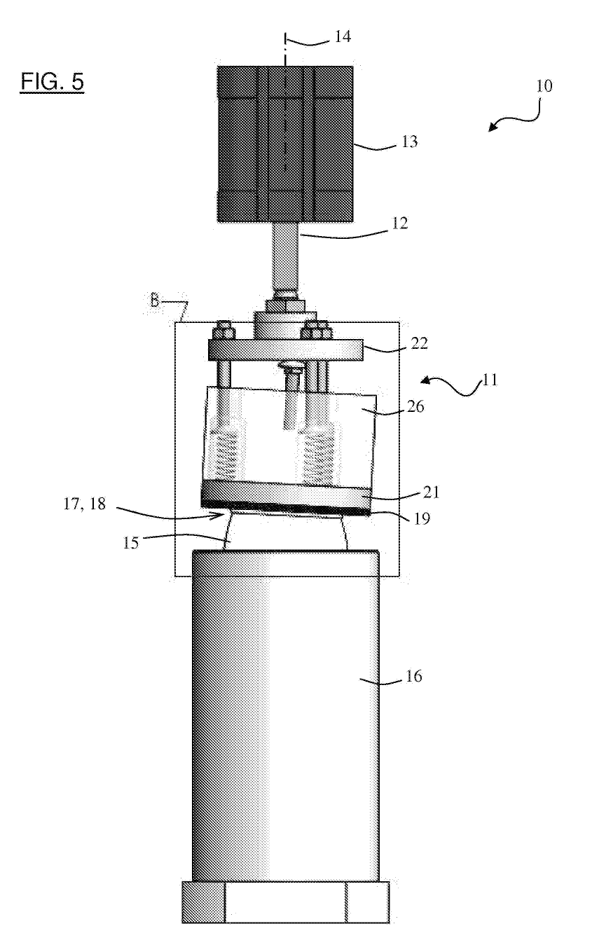

With reference to FIGS. 4 and 5 in particular, the heat-sealing device 10 comprises a heat-sealing tool 11 that is mounted at the bottom end of the rod 12 of an actuator 13 serving to move the tool 11 in translation along the longitudinal axis 14 of the actuator 13 and of the rod 12, which axis is substantially vertical.

A glass 15 that is (partially) filled with a beverage is arranged on a glass support 16 that is arranged on, and movable by, a conveyor that is not shown.

The support 16 presents a cylindrical cavity of vertical axis that can be made to be substantially in alignment with the axis 14 by the conveyor moving the support 16.

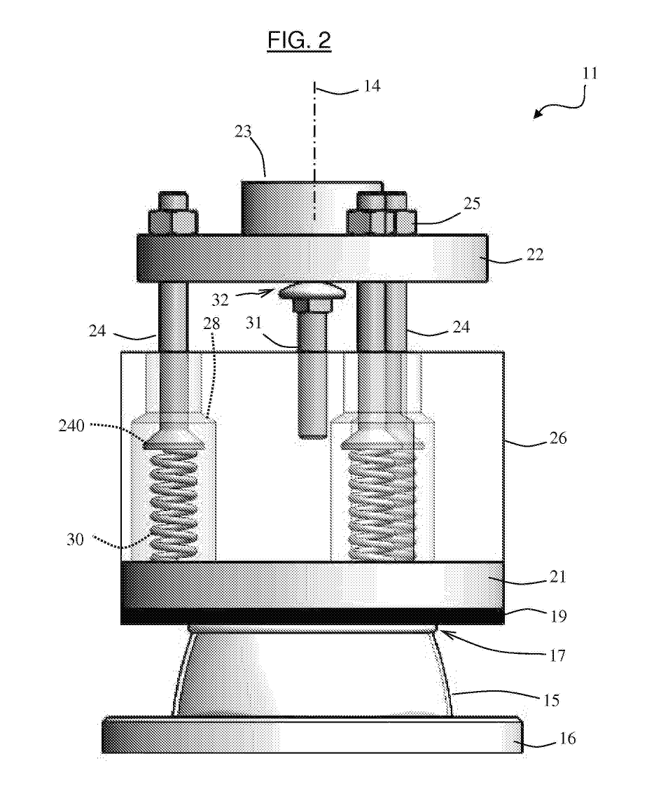

The bottom portion of the glass 15 is engaged in this cavity of the support 16, so that only the top portion of the glass, including the rim 17, can be seen in FIGS. 2 to 5.

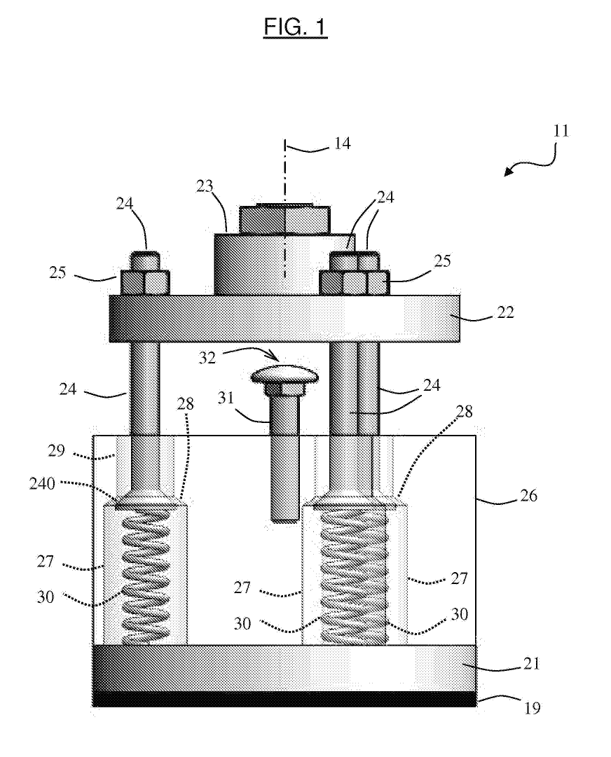

With reference to FIGS. 1 to 3 and 6 in particular, the heat-sealing tool 11 comprises a thermally conductive element 19, a heater element 20, and a metal part 21 that is secured to and in thermal contact with the conductive element 19 and the heater element 20.

The part 21 may be in the form of a disk having a bottom face to which the conductive element 19 can be secured by vulcanization.

In order to seal a film lid, the heater element 20 is powered by a source of electricity (not shown).

The heat given by the heater element is transmitted to the part 21 which heats up, in turn heating the conductive element 19.

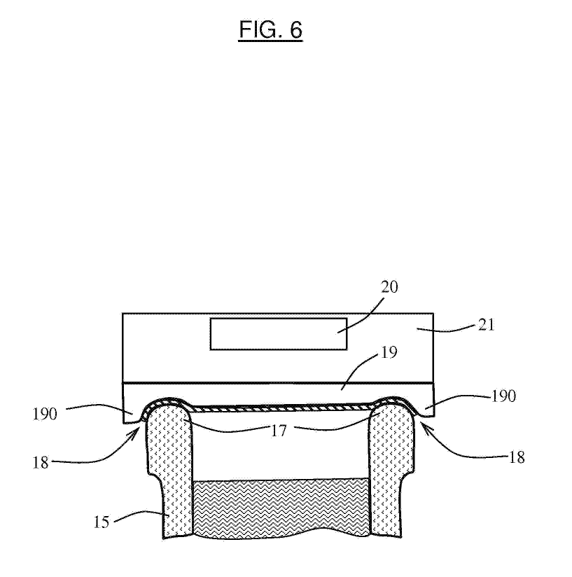

As shown in FIG. 6, the thermally conductive element 19 is designed to press against the film lid 18 and against the rim 17 in order to heat the film lid and the rim during heat sealing, a peripheral portion 190 of the conductive element 19 extending outside the rim.

For this purpose, the conductive element 19 may be in the form of a disk or a ring of outside diameter that is greater than the diameter of the rim.

In particular when the glass is made of plastics material and has a rim with a rib, resting the heated conductive element against the film lid and against the rim causes the rib to deform plastically during sealing, and the pressure exerted on the film lid and the rim by the peripheral portion 190 of the conductive element that extends beyond the rim while matching the shape of the outside face of the rim can cause the outer portion of the rim to be curved, and/or can cause the peripheral portion of the film lid to be heat sealed to a peripheral portion of the rim, along at least the portion of its curved profile.

With reference to FIGS. 1 to 3 in particular, the tool 11 includes a first tool portion, or top tool portion, that is designed to be fastened to the rod of the actuator 13.

This top tool portion comprises a part 22 that is in the form of a disk or plate, that extends in a plane perpendicular to the travel axis 14 of the tool 11, and that is secured to a bushing 23 for fastening the plate 22 to the rod of the actuator.

The first tool portion also has three rods 24 parallel to the axis 14 that extend from the underside of the plate 22 and that are screwed into the plate 22 and held by nuts 25 bearing against the top face of the plate.

The tool 11 also includes a second tool portion, or bottom tool portion, that is hinged to and suspended from the first tool portion.

This second tool portion. includes the metal part 21 that is in the form of a disk about the axis 14 and that receives the heater element 20 (cf. FIG. 6), and it also includes the deformable conductive element 19.

The second tool portion also has a body 26 pierced by three mutually parallel channels 27, that extends in line with and above the part 21 to which the body 26 is secured.

Each channel 27 extends inside the body 26 from the part 21 and along a longitudinal axis that is parallel to the axis 14.

Each channel includes a narrow portion 29 (i.e. a portion of smaller diameter) that is connected to and coaxial with the widest portion of the channel 27 via a frustoconical connection surface forming an abutment 28, and each channel opens out in the top face of the body 26.

Each channel 27 receives a helical spring 30 extending along the longitudinal axis of the channel in the wider bottom portion of the channel, with each spring 29 pressing against the part 21 at the bottom of the corresponding channel.

The relative positioning of the channels 27, 28, 29 is identical to the relative positioning of the rods 24, which are engaged in part in respective ones of the channels 27 to 29.

In particular, the channels may be equidistant in pairs, and the points of intersection of the three respective axes of the three channels with a plane perpendicular to those axes form the three vertices of an equilateral triangle in that plane.

Each rod 24 has a flat head 240 that is received in the widest portion 27 of the corresponding channel, via which head the rod presses against the top end of the spring 30 received in the channel 27.

The head 240 of each rod 24 extends between the top end of the spring 30 received in the channel and the narrowing that forms the abutment 28, and it presents a diameter that is greater than the diameter of the narrow portion 29 of the channel such that the abutment 28 prevents the rods 24 from escaping from the channels 27 to 29.

Each rod is arranged and dimensioned to slide in the corresponding channel 27 to 29 with a large amount of radial clearance making it possible in particular for the rod to slope freely relative to the longitudinal axis of the channel in the event of the rim and the heat-sealing tool being out of parallel.

Each rod 24 can slide between a first position shown in particular in FIG. 1, in which the head 240 of the rod presses against the abutment 28, and a second position shown in particular in FIG. 2, in which the head 240 or the rod is remote from the abutment 28, and in which the spring 30 against which the head 240 is pressing is compressed to a greater extent than in the first position of the rod.

The bottom tool portion also has a bearing surface 32 of rounded shape that is secured to the body 26 and that extends between the body 26 and the part 22.

The bearing surface 32 may be constituted by the domed, e.g. spherical, face of the head of a screw 31 that is fastened to the central portion of the body 26.

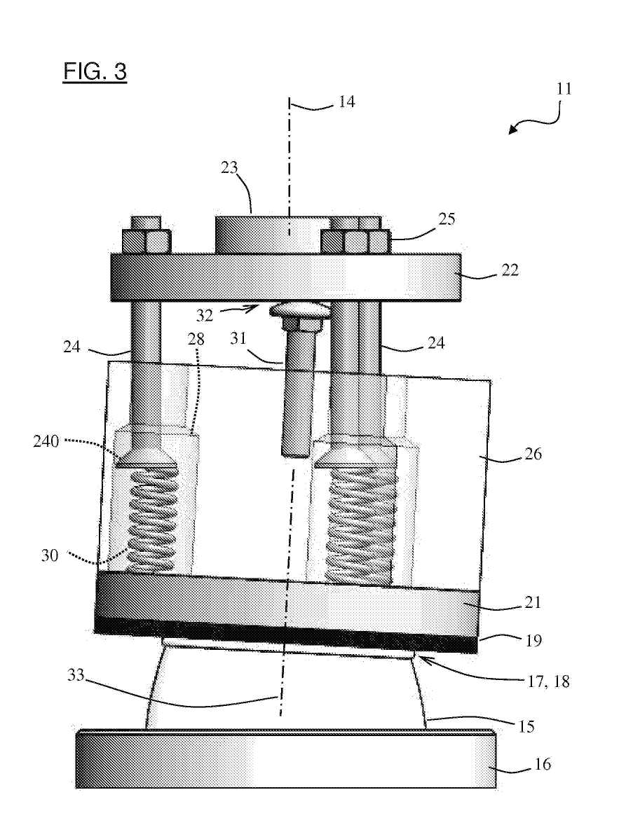

When the bearing surface 32 comes into contact with the bottom face of the part 22 under the effect of the springs 30 being compressed, and regardless of whether the bottom and top tool portions are in alignment on the same axis as shown in FIG. 2 in particular, or not in alignment as shown in FIG. 3 in particular, the screw 31 and the bearing surface 32 serve to transmit, to the bottom tool portion, the force that is transmitted by the actuator to the top portion of the tool.

As can be seen in particular by comparing FIGS. 1 and 2, the rods 24 having their heads pushed towards the abutments 28 by the springs 30 and the channels receiving the rods and enabling them to slide and to pivot/tilt through a small amplitude, thus form means for suspending and hinging the rigid assembly constituted by the body 26, the part 21, and the conductive element 19 relative to the plate 22, and thus relative to the rod 12 of the actuator 13.

These suspension means serve in particular to allow the conductive element 19 to move in translation relative to the linear actuator, on the axis 14 along which the element is moved by the actuator.

As can be seen in particular by comparing FIGS. 1 to 3, the ability of the rods 24 to tilt relative to the channels in which they are engaged, the possibility for the three springs 30 to be compressed differentially, and the small stiffness of the springs, enable the conductive element 19 to be hinged relative to the top portion of the tool, which is itself rigidly connected to the rod of the actuator: these means allow this element 19 together with the parts 21 and 26 to pivot substantially freely about two substantially orthogonal pivot axes, in particular about two pivot axes that may be substantially perpendicular to the travel axis 14 of the actuator an to the axis of the pressure force exerted by the conductive element on the film lid and on the rim.

These means for hinging and suspending the bottom and top tool portions relative to each other thus act like a ball joint having its instantaneous center of rotation automatically occupying the point of first contact of the element 19 on the film lid and the rim.

These hinge and suspension means have the advantage of preventing the bottom portion or the tool from progressively transmitting a “tangential” or lateral force to the film lid and/or to the rim as the element 19 is put into contact with the film lid, thereby avoiding giving rise to a positioning defect (a centering defect) of the film lid on the rim, or a defect of the film lid slipping or creasing, in the event of the rim and the tool being out of parallel.

These hinge and suspension means enable the pressure force and the heat flux to be well distributed all around the rim, even when the rim initially slopes relative to the element 19.

Furthermore, after each heat-sealing operation, when the rod 12 is retracted by the actuator 13, the heads 240 of the rods 24 return against the conical bearing surfaces 28 in the channels, thereby causing the bottom and top tool portions to be mutually centered and aligned, with the bottom and top tool portions moving apart from each other so that the bearing surface 32 moves away from the bottom face of the part 22.

1. A device (10) for heat sealing a film lid (18) on the rim (17) of a glass (15), the device including:
a heat-sealing tool (11) having a deformable and thermally conductive element (19), a heater element (20), and a metal part (21) secured to the conductive element and to the heater element, the deformable and thermally conductive element (19) being designed to press against the film lid and the rim in order to heat the film lid and the rim, a peripheral portion (190) of the conductive element (19) being arranged to extend beyond the rim;
an actuator (13) for moving the heat-sealing tool (11);
means (24, 240, 26 to 30) for hinging and suspending the deformable conductive element; and
force transmission means (31, 32) for transmitting a pressure force exerted by the actuator (13) to the conductive element (19), these force transmission means being distinct from the means for hinging and suspending the conductive element.

2. (canceled)

3. A device according to claim 1, wherein the means for hinging and suspending the deformable conductive element comprise at least one guide member (24) that enables the conductive element (19) and the actuator (13) to move in translation relative to each other.

4. A device according to claim 1, wherein the heat-sealing tool includes a first tool portion fastened to a rod (12) of the actuator (13), and a second tool portion hinged to and suspended from the first tool portion, the second tool portion including the metal part (21), the heater element (20), and the conductive element (19).

5. A device according to claim 4, wherein one of the first and second tool portions has a body (26) pierced by parallel channels (27 to 29), each channel including an abutment (28) and receiving a spring (30) extending along the longitudinal axis of the channel, and the other one of the first and second tool portions includes parallel guide members (24) that are partially engaged in respective ones of the channels (27 to 29), and that press against respective springs (30), each guide member being arranged to slide in one of the channels with clearance allowing it to tilt relative to the longitudinal axis of the channel, the abutments (28) preventing the guide members escaping from the channels (27 to 29).

6. A device according to claim 5, wherein the number of channels (27 to 29) and the number of guide members (24) are equal to three, the channels and the guide members being equidistant in pairs.

7. A device according to claim 1, wherein the heat-sealing tool is mounted to pivot about a horizontal axis in order to enable a film lid to be gripped by a pneumatic gripper that is incorporated in the heat-sealing tool.

8. A device according to claim 1, wherein the means for hinging and suspending the deformable conductive element enable this element to pivot about two substantially orthogonal pivot axes.

9. A device according to claim 4, wherein the force transmission means comprise a force transmission part (31) rigidly connected to one of the lust and second tool portions, the transmission part including a bearing surface (32) extending between the first and second tool portions.

10. A device according to claim 1, including a device for introducing inert gas into the head space of the glass with the help of a porous structure.

11. A device according to claim 1, wherein the conductive element (19) is in the form of a disk or a ring of outside diameter greater than the outside diameter of the rim.

12. A method of heat sealing a film lid on the rim of a glass in which use is made of a heat-sealing device according to claim 1.

13. A method according to claim 12, wherein the glass is made of plastics material.

14. A method according to claim 13, wherein the rim of the glass presents a rib which is deformed plastically during heat sealing of the film lid.

15. A method according to claim 12, wherein the pressure exerted on the film lid and on the rim by the conductive element (19) that extends beyond the rim leads to rounding, or curving, of the outside portion of the rim.

16. A method according to claim 12, wherein the ring (17) of the glass, at the end of heat sealing, has a section of curved outline, and wherein the conductive element (19) presents thickness, diameter, and elasticity that are sufficient to deform so as to fit closely to the lateral peripheral portion of the rim in order to enable the peripheral portion of the film lid to be heat sealed to a peripheral portion of the rim along its curved profile.

17. A method according to claim 12, wherein the conductive element (19) exerts a pressure force on the film lid and on the rim between the heat-sealing tool coming into contact with the rim and the end of the stroke imparted by an actuator to the conductive element, which force is less than that needed for heat is the film lid on the rim.

18. A method according to claim 12, wherein the film lid is indented and/or stamped, at least in part.

19. A method according to claim 12 in which the glass contains a beverage.

20. A device according to claim 8, wherein the bearing surface (32) is domed.

21. A method according to claim 19 wherein the beverage is wine.
